(19) United States
(12) Patent Application Publication
(10) Pub. No.: US 2016/0215971 A1
(43) Pub. Date: Jul. 28, 2016

(54) Interfaith Holiday Tree

(71) Applicants: Scott Charles Silver, Glendale, CA (US); Max Aaron Silver, Boca Raton, FL (US)

(72) Inventors: Scott Charles Silver, Glendale, CA (US); Max Aaron Silver, Boca Raton, FL (US)

(21) Appl. No.: 14/606,100

(22) Filed: Jan. 27, 2015

(51) Int. Cl. F21V 33/00; F21V 25/00; F21V 23/04; A47G 33/06; F21V 23/00

(52) U.S. Cl. CPC F21V 33/0028; A47G 33/06; F21V 23/001; F21V 23/002; F21V 23/0435; F21V 25/00; F21V 33/0076; F21W 2121/04

(57) ABSTRACT

An electric or non-electric candle holder formed in the shape of a holiday tree having a plurality of movable branches that are formed to hold electric or non-electric candles on the branches and also formed to hold at least one holiday ornaments on the branches. The tree shape may be in the form of an evergreen or pine tree and may further have a symmetrical number of branches on either side of a single central trunk so that the holiday tree may be used for Hanukkah celebrations or, in a different configuration, for Kwanzaa celebrations. In further embodiments, the holiday tree may include wireless connectivity to allow for control of individual lighting via a smart phone app or other remote device, or may also include one or more monitors or sensors to alert for smoke, carbon dioxide, motion, or breakage, including glass breakage.

### FIELD OF THE INVENTION

The present invention generally relates to holiday decorations. More particularly, the disclosed invention relates to an electric or non-electric candle holiday tree. In further detail, the holiday tree, in preferred embodiments, combines the ornamental features of a Christmas tree shape and lights with the features of nine distinct candles used in a Hanukkah menorah, or the features of seven distinct candles as used in Kwanzaa celebrations.

### BACKGROUND OF THE INVENTION

Holiday celebrations for varied religious denominations often use candles or lights as a celebratory symbol. Prime examples of such use of lights as a celebratory symbol include, by way of example, Christmas, Hanukkah, Kwanzaa and other holidays. There are, for example, Christmas trees, Hanukkah menorahs, Hanukkah bushes, Kwanzaa candles, and many others. Each such holiday symbol has a distinctive configuration or shape and/or a specific number of lights or candles. Christmas trees, for example, are generally in the shape of an evergreen or pine tree decorated with a multitude of lights. A Hanukkah menorah has nine total lights, while there are seven lights used for Kwanzaa celebrations.

As families have diversified, today many families celebrate multiple holidays, including Christmas and Hanukkah, Christmas and Kwanzaa, and Hanukkah and Kwanzaa. While the dates of the celebrations often do not overlap, for many years, Christmas, Hanukkah, and Kwanzaa celebrations do occur on overlapping dates. On those occasions where an overlap of distinct holidays occurs, multiple holiday decorations are placed throughout homes, shopping areas, and places of business. Instead of having distinct and separate celebratory symbols, some interfaith families often find it enjoyable to combine certain of their holiday celebratory traditions.

Some products have been developed to attempt to address this desire for combined celebratory symbols. There is for example a “menorah tree” which is no more than a menorah shaped device having nine vertical arms, with the menorah arms wrapped or covered in a green leaf or needle-like material. None of the prior art devices, however, have effectively addressed the need for an aesthetically pleasing and combined celebratory holiday symbol.

Accordingly what is needed is an apparatus that can be used to symbolize the celebratory aspects of Christmas and Hanukkah, or Christmas and Kwanzaa, or other combined holidays. Such an apparatus should present ornamental and utility aspects of the joint holidays being celebrated, and still be true to each individual holiday symbolism. Such celebratory items or devices or decorations do not appear to have been fully and specifically designed or used in the prior art.

### SUMMARY OF THE INVENTION

The above noted problems inadequately or incompletely resolved by the prior art are addressed and resolved by the present invention.

A preferred embodiment of the invention is an electric candle holder shaped as a holiday evergreen tree for use with holiday celebrations, comprising (a) a single central trunk, having a top end and a bottom end, said central trunk top end comprising an element to hold an electric bulb; (b) a plurality of branches rotatably connected to said single central trunk, wherein each such plurality of branches comprising at its distal end an element to hold an electric bulb; (c) a base section to which said central trunk bottom end is attached; and (d) electric wiring running within said central trunk and each of said plurality of branches to provide electrical current to said trunk and branches elements to hold an electric bulb.

Another preferred embodiment of the invention is a non-electric candle holder shaped as a holiday evergreen tree for use with holiday celebrations, comprising (a) a single central trunk, having a top end and a bottom end, said central trunk top end comprising an element to hold a candle; (b) a plurality of branches rotatably connected to said single central trunk, wherein each such plurality of branches comprising at its distal end an element to hold a candle; and (c) a base section to which said central trunk bottom end is attached.

The invention will be best understood by reading the following detailed description of the preferred embodiments in conjunction with the drawings briefly described below.

### BRIEF DESCRIPTION OF THE DRAWINGS

For the purposes of illustrating the invention, the attached drawings show several aspects and embodiments that are presently preferred. However, it should be understood that the invention is not limited to the precise arrangement and configuration shown in the accompanying drawings.

FIG. 1: is a front view of an exemplary embodiment of the present inventive holiday tree display with several decorations and having eight total branches and a central trunk;

FIG. 2: is another front view of the exemplary embodiment of the present inventive holiday tree showing a basic framework of the tree as also shown in FIG. 1;

FIG. 3: is a front view of an exemplary embodiment of the present inventive holiday tree showing a basic framework of the tree having six total branches and a central trunk;

FIG. 4: is a top view of an exemplary embodiment of the present inventive holiday tree showing a basic framework of the tree having eight total branches and a central trunk;

FIG. 5: is a perspective view of an exemplary embodiment of the present inventive holiday tree showing a basic framework in addition to switching and sensors located on the base; and

FIG. 6: is an illustration of an overhead internal view of an exemplary embodiment of the base section as used with the present inventive holiday tree, along with an alarm, processor and receiver for use with at least one remote wireless device.

### DETAILED DESCRIPTION OF SEVERAL EMBODIMENTS

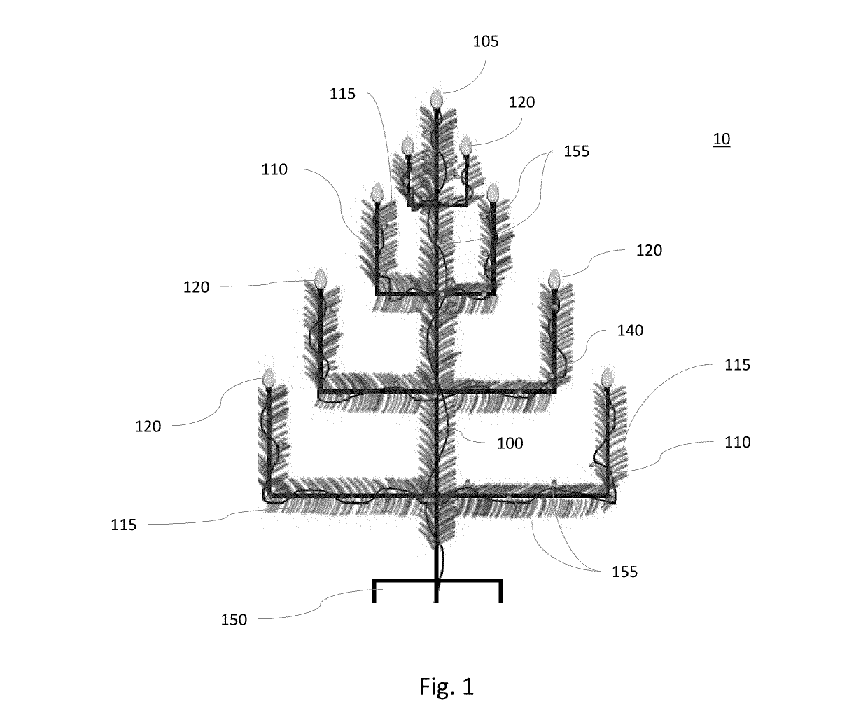

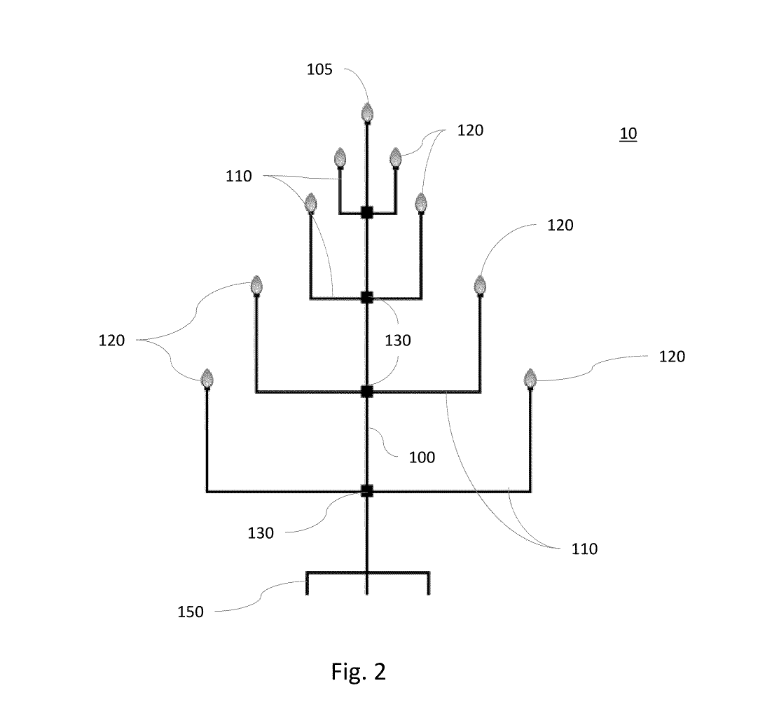

The following provides a disclosure of an inventive holiday tree shaped electric light display, or non-electric candle holder. The holiday tree may include or use electric and/or non-electric candles. In one preferred embodiment, as shown in FIGS. 1 and 2, the holiday tree 10 has a central trunk 100 having either an electric or non-electric candle 105 at its top terminating end. The holiday tree 10 further has a plurality of branches 110 rotatably attached to the central trunk 100 at different heights along the central trunk 100. Similar to the central trunk 100, each of the branches 110 has either an electric or non-electric candle 120 positioned at the end of each branch 110. The electric candles 120 (or bulbs) may be an incandescent bulb of different size or wattage, or for increased energy efficiency, the holiday tree 10 is configured to alternatively use light emitting diodes (LED) of various lumens output.

The branches 120 are each rotatably connected to the central trunk 110 by a collar or O-ring device 130 that allows for repositioning of each branch 110 with a slight force. In an alternative embodiment, the collar or O-ring device 130 may be able to tightened or locked into position so that each branch is held in place until the collar 130 is loosened to allow the branch 110 to be repositioned.

The branches 110 and central trunk 110 may be manufactured, as shown in FIG. 1, with pine needles 115 to resemble the branches of an evergreen tree. The pine needles 115 attached to or formed on the branches 110 and central trunk 100 should be flexible but resilient for increased durability and aesthetic appeal as a holiday tree 10.

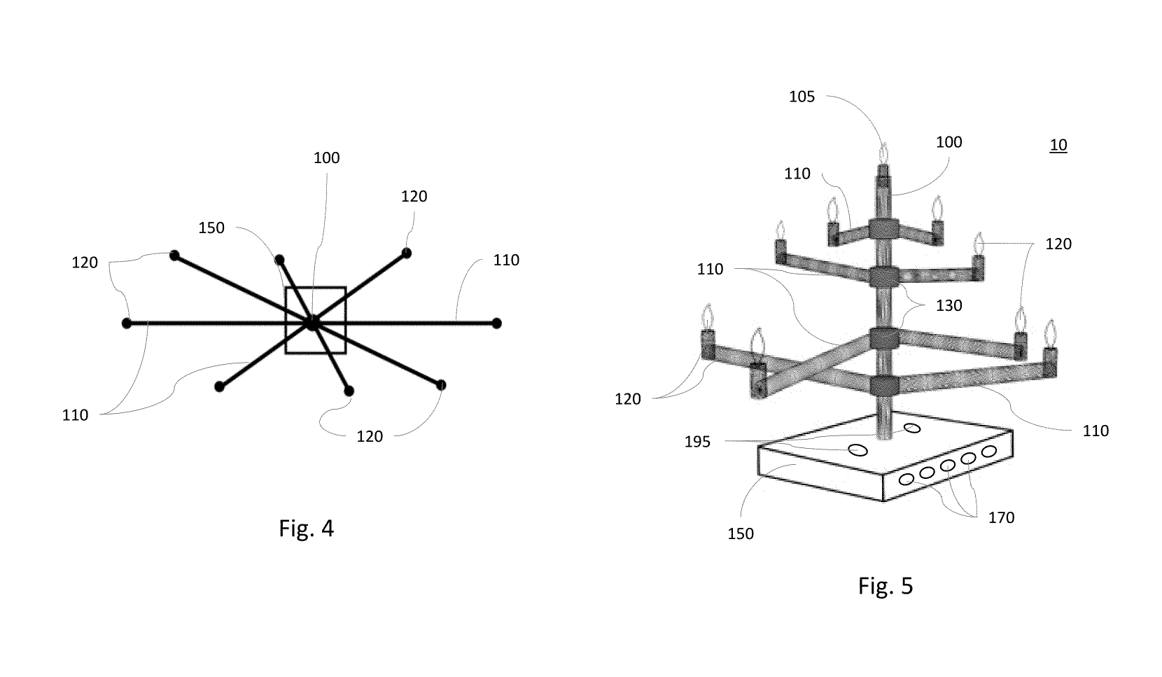

In one embodiment, eight total branches 110 may be attached to the central trunk 100, such that each successive branch 110 attached to the central trunk 100 is shorter in length as they approach the top of the central trunk 100, as illustrated in FIGS. 1 and 2. In this configuration, the holiday tree 10 resembles an evergreen or pine tree similar to a Christmas tree. Also in this configuration, the holiday tree 10 resembles an innovative Hanukkah menorah in view of the eight individual branches 110 and candles 120 surrounding the central trunk 100 or Shamash and its respective candle 105. Because the plurality of branches 110 are rotatably attached to the central trunk 100 by a collar device 130, the holiday tree 10 may be configured relatively flat, similar to a traditional holiday menorah, as shown in FIGS. 1 and 2, or the tree may be configured along three dimensions. In the 3-D configuration, as shown in FIGS. 4 and 5, each branch 110 may be rotated about the central trunk 100 in a forward or aft direction thereby creating a three-dimensional tree shape that resembles both, and may be used as both, a Christmas tree and a Hanukkah menorah.

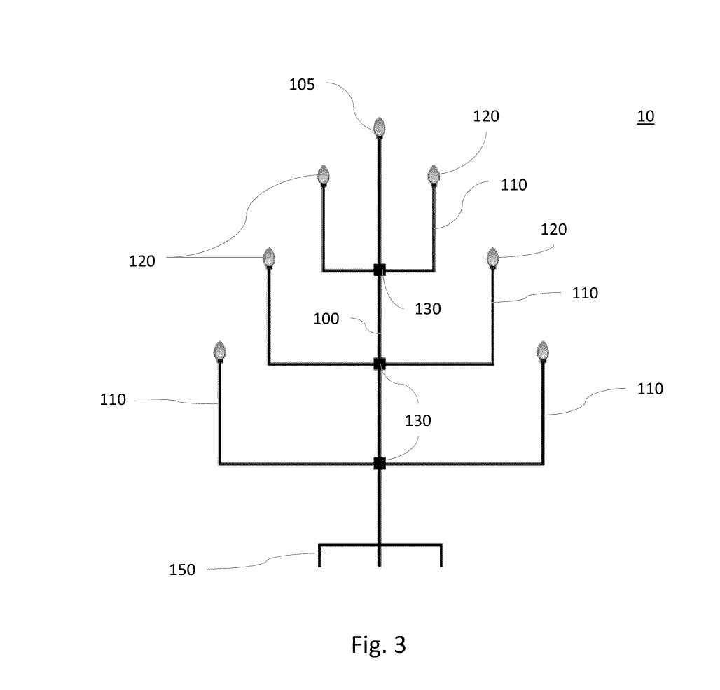

As also shown in FIGS. 1 through 3, in various embodiments, the distal end of each branch 110, or the end of each branch 110 that is opposite to the end attached to the collar device 130 and central trunk 100, may be angled upwards before it ends in the electric or non-electric candle 120. In different embodiments, each branch 110 may be attached to the central trunk 100 at a non-orthogonal orientation, and similarly, the distal end of each branch 110 may also angle upwards in a non-orthogonal orientation. In a further embodiment, the branches 110 may be manufactured from a resilient and flexible material that allows the user to reposition each branch 110 at varied angles to allow the user to provide some personal uniqueness and aesthetic appeal to the holiday tree shape and design. Moreover, the branches 110 of the holiday tree 10 are designed to be resilient enough to also be used to hang other decorations from, similar to a traditional Christmas tree, and thereby expand the decoration utility of the holiday tree 10 generally, and the branches 110 of the holiday tree 10 more specifically.

FIG. 1 also shows an embodiment with the wiring 140 for each electric bulb socket positioned at the distal end of the central trunk 100 and each of the branches 110 running exterior to and wound around the trunk 100 and each branch 110, with all such wires being collected at the base 150 for connection to a series of control switches 170 (as also illustrated in FIG. 5). Alternatively, the central trunk 100 and each branch 110 can be manufactured as hollow tubes to permit the wiring 140 to run within the trunk 100 or branch 110 and thereby provide a cleaner configuration. In one embodiment as illustrated in FIG. 1, the wiring 140 extending from the base section 150 to the candle sockets 120 may also include a plurality of smaller or miniature lights 155, shown in a different color from the distal end candle bulbs 105, 120, in FIG. 1, to provide additional ornamentation to the holiday tree configuration.

As noted, the base 150 of the holiday tree 10 may include a series of electrical switches 170, shown in FIG. 5, to allow users to select the individual lights/candles to power, for example, one candle (and the Shamash) for each night of Hanukkah, or all lights on the last day of Hanukkah or during the Christmas celebration. In an alternative configuration, where the lights 105, 120 are controlled remotely through a wireless device, such as a smartphone, there may be no need for including individual switching 170 on the base section 150, thereby providing for a cleaner design for the base section 150. Where the holiday tree uses LED bulbs, and remotely controls the LED bulbs through a wireless device, such as a smart phone and app, such an embodiment provides the ability to individually control the color of each bulb as it is turned on. In such an embodiment, each branch bulb and the central trunk bulb may be a different color providing an additional creative aspect for holiday decoration.

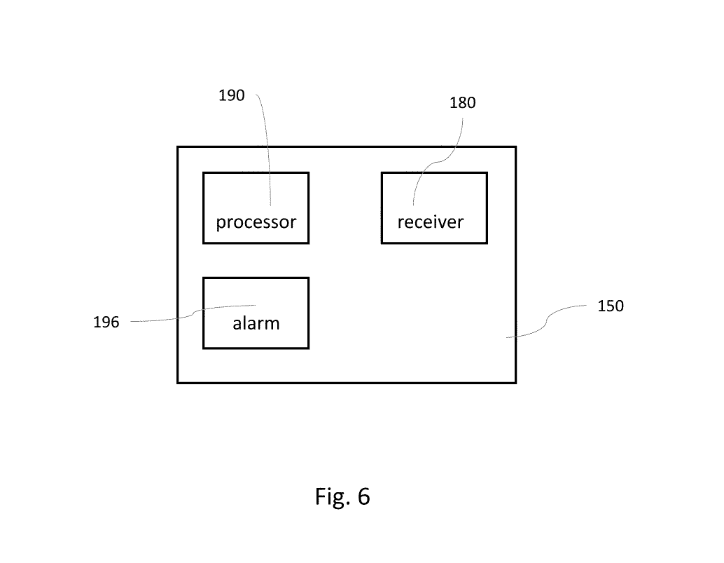

As noted, in a further embodiment depicted in FIG. 6, a receiver 180 and processor 190 may be housed within the base 150 to allow for remote control of each individual candle/bulb 105, 120 as well as for other features. Through the use of a receiver 180, the individual candles 105, 120 may be controlled by a smartphone and a smartphone app. Extending upon this preferred embodiment, the holiday tree 10 may further comprise one or more sensors or monitors 195 to sense for abnormal conditions in the proximity of the holiday tree. Such sensors 195 may be one or more of a smoke detector, a carbon monoxide detector, a motion detector, or a glass breakage monitor. Such sensors or monitors 195 (shown in one embodiment in FIG. 5) may also include internal aural alarms 196, or in an alternative embodiment, each sensor or monitor 195 may wirelessly communicate with a transceiver and processor 190 located in the base to send an alarm signal to a remote device if an abnormal condition is sensed by one or more of the sensors 195. Such a remote device could be a house security system, or one or more smartphones.

In a preferred embodiment, for safety concerns, certain sections or elements of the holiday tree 10 may be manufactured from fire resistant materials. For example, the central trunk 100, plurality of branches 110, and/or the pine needles 115 may be manufactured from fire resistant materials. As should be understood from the drawings and the above description, the holiday tree 10 may be manufactured to be most any size. A smaller holiday tree may be sized to fit on a small table or window sill. Such a holiday tree could be approximately two feet or less in height. Alternatively, the holiday tree may be manufactured to be free standing, and have a height of approximately 5 to 7 feet tall or more.

While preferred embodiments of the inventive methods and systems have been described and disclosed, in particular by reference to certain figures and exemplary embodiments relating to holiday tree shaped candle holders, such type of holiday tree configurations are not to be construed as limiting the scope of application of the inventive devices or products. For example, alternative means for attaching the branches to the central trunk, or the use of different materials for the leaves or needles of the branches could be incorporated into the holiday tree design to provide other configurations that may be equally useful and operational. Similarly, alternative remote control means for the lights, and alternative monitors or sensors may be incorporated into alternative embodiments of the holiday tree.

It will be recognized by those skilled in the art that such other modifications, substitutions, and/or other applications are possible and all such modifications, substitutions and applications are within the true scope and spirit of the present invention. It is likewise understood that the above disclosure and attached claims are intended to cover all such modifications, substitutions, and/or applications.

What we claim is:

1. An electric candle holder shaped as a holiday tree for use with holiday celebrations, comprising:
a. a single central trunk, having a top end and a bottom end, said central trunk top end comprising an element to hold an electric bulb;
b. a plurality of branches rotatably connected to said single central trunk, wherein each such plurality of branches comprising at its distal end an element to hold an electric bulb;
c. a base section to which said central trunk bottom end is attached; and
d. electric wiring running to said distal end of said central trunk and each of said plurality of branches to provide electrical current to said trunk and branches elements to hold an electric bulb.

2. The candle holder shaped as a holiday tree for use with holiday celebrations, as in claim 1, wherein a total of eight branches are rotatably connected to said single central trunk.

3. The candle holder shaped as a holiday tree for use with holiday celebrations, as in claim 1, wherein a total of six branches are rotatably connected to said single central trunk.

4. The candle holder shaped as a holiday tree for use with holiday celebrations, as in claim 1, wherein said electric wiring running to said distal end of said central trunk and each of said plurality of branches, runs within a hollowed section of said central trunk and each of said plurality of branches.

5. The candle holder shaped as a holiday tree for use with holiday celebrations, as in claim 1, further comprising control software such that each branch bulb and said central trunk bulb may be individually turned on or turned off remotely by a wireless device.

6. The candle holder shaped as a holiday tree for use with holiday celebrations, as in claim 5, wherein said wireless device is a smartphone using a software app.

7. The candle holder shaped as a holiday tree for use with holiday celebrations, as in claim 1, further comprising at least one wireless monitor to sense for abnormal conditions.

8. The candle holder shaped as a holiday tree for use with holiday celebrations, as in claim 7, further comprising software to transmit an alarm signal to a wireless device after an abnormal condition is sensed by said at least one wireless monitor.

9. The candle holder shaped as a holiday tree for use with holiday celebrations, as in claim 7, wherein said at least one wireless monitor is a smoke detector.

10. The candle holder shaped as a holiday tree for use with holiday celebrations, as in claim 7, wherein said at least one wireless monitor is a carbon monoxide detector.

11. The candle holder shaped as a holiday tree for use with holiday celebrations, as in claim 7, wherein said at least one wireless monitor is a glass breakage detector.

12. The candle holder shaped as a holiday tree for use with holiday celebrations, as in claim 7, wherein said at least one wireless monitor is a motion detector.

13. A non-electric candle holder shaped as a holiday evergreen tree for use with holiday celebrations, comprising:
a. a single central trunk, having a top end and a bottom end, said central trunk top end comprising an element to hold a candle;
b. a plurality of branches rotatably connected to said single central trunk, wherein each such plurality of branches comprising at its distal end an element to hold a candle; and
c. a base section to which said central trunk bottom end is attached.

14. The non-electric candle holder shaped as a holiday evergreen tree for use with holiday celebrations, as in claim 13, wherein a total of eight branches are rotatably connected to said single central trunk.

15. The non-electric candle holder shaped as a holiday evergreen tree for use with holiday celebrations, as in claim 13, wherein a total of six branches are rotatably connected to said single central trunk.

16. The non-electric candle holder shaped as a holiday evergreen tree for use with holiday celebrations, as in claim 13, further comprising at least one wireless monitor to sense for abnormal conditions.

17. The non-electric candle holder shaped as a holiday evergreen tree for use with holiday celebrations, as in claim 16, further comprising software to transmit an alarm signal to a wireless device after an abnormal condition is sensed by said at least one wireless monitor.

18. The non-electric candle holder shaped as a holiday evergreen tree for use with holiday celebrations, as in claim 16, wherein said at least one wireless monitor is a smoke detector.

19. The non-electric candle holder shaped as a holiday evergreen tree for use with holiday celebrations, as in claim 16 wherein said at least one wireless monitor is a carbon monoxide detector.
